(19) United States
(12) Patent Application Publication
(10) Pub. No.: US 2023/0032998 A1
(43) Pub. Date: Feb. 2, 2023

(54) VEHICULAR OBJECT DETECTION AND DOOR OPENING WARNING SYSTEM

(71) Applicant: Magna Electronics Inc., Auburn Hills, MI (US)

(72) Inventors: Pushpendra Kushwaha, Uttar Pradesh (IN); Tejas Murlidhar Varunjikar, Troy, MI (US); Kirti Hiranand Balani, Maharashtra (IN)

(21) Appl. No.: 17/815,675

(22) Filed: Jul. 28, 2022

Related U.S. Application Data
(60) Provisional application No. 63/203,766, filed on Jul. 30, 2021.

(51) Int. Cl. B60Q 9/00; B60R 25/31

(52) U.S. Cl. CPC B60Q 9/008; B60R 25/31

(57) ABSTRACT

A vehicular alert system includes a sensor disposed at a vehicle. The system, using the sensor, determines that a moving object is moving toward the vehicle. Responsive to determining a likelihood the occupant of the vehicle is going to exit the vehicle via the door of the vehicle, and responsive to determining that the detected moving object is moving toward the vehicle, the vehicular alert system (i) determines distance between the detected moving object and the door of the vehicle, and (ii) determines a heading angle of the detected moving object relative to the vehicle. The vehicular alert system determines whether the detected moving object is a threat based at least in part on (i) the determined distance and (ii) the determined heading angle. The vehicular alert system, responsive to determining that the detected moving object is a threat, alerts the occupant of the vehicle.

### CROSS REFERENCE TO RELATED APPLICATION

The present application claims the filing benefits of U.S. provisional application Ser. No. 63/203,766, filed Jul. 30, 2021, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

A vehicular alert system includes a sensor disposed at a vehicle equipped with the vehicular alert system. The sensor senses exterior of the vehicle and captures sensor data. The system includes an electronic control unit (ECU) with electronic circuitry and associated software. The electronic circuitry of the ECU includes a processor for processing sensor data captured by the sensor. The vehicular alert system determines a likelihood that an occupant of the vehicle is going to exit the vehicle via a door of the vehicle. The processor processes sensor data captured by the sensor to detect a moving object present exterior of the vehicle. Responsive to detecting the moving object, the vehicular alert system determines that the moving object is moving toward the door of the vehicle. Responsive to determining the likelihood the occupant of the vehicle is going to exit the vehicle via the door of the vehicle, and responsive to determining that the detected moving object is moving toward the door of the vehicle, the vehicular alert system (i) determines distance between the detected moving object and the door of the vehicle, and (ii) determines a heading angle of the detected moving object relative to the vehicle. The vehicular alert system determines whether the detected moving object is a threat based at least in part on (i) the determined distance and (ii) the determined heading angle. The vehicular alert system, responsive to determining that the detected moving object is a threat, alerts the occupant of the vehicle.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vehicular alert system that incorporates sensors;

FIG. 2 is a schematic view of a vehicle with a plurality of door opening warning zones;

FIG. 3 is a block diagram for exemplary modules of the system of FIG. 1; and

FIG. 4 is a block diagram for a door opening warning threat assessment module of the system of FIG. 1.

### DESCRIPTION OF THE PREFERRED EMBODIMENTS

A vehicular alert system and/or object detection system operates to capture images or sensor data exterior of the vehicle and may process the captured image data or sensor data to detect objects at or near the vehicle, such as to assist an occupant in determining whether the detected object is a threat. The alert system includes a processor or image processing system that is operable to receive image data or sensor from one or more cameras or sensors. Optionally, the vision system may provide a display, such as a rearview display or a top down or bird's eye or surround view display or the like.

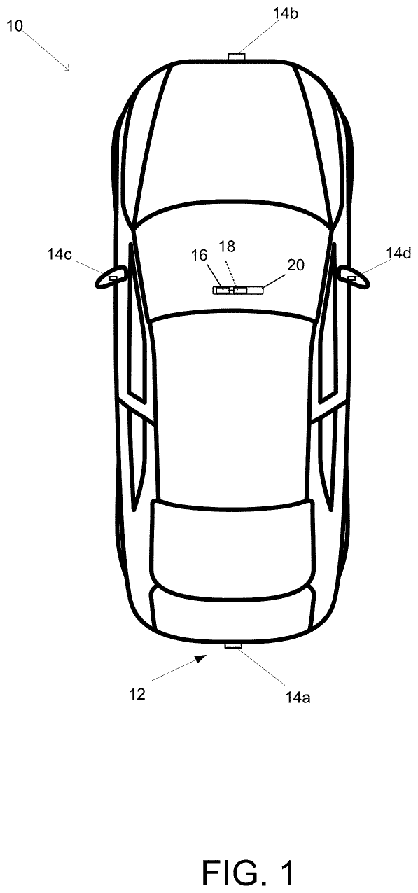

Referring now to the drawings and the illustrative embodiments depicted therein, a vehicle 10 includes an imaging system or vision system 12 that includes at least one exterior viewing imaging sensor or camera, such as a rearward viewing imaging sensor or camera 14a (and the system may optionally include multiple exterior viewing imaging sensors or cameras, such as a forward viewing camera 14b at the front (or at the windshield) of the vehicle, and a sideward/rearward viewing camera 14c, 14d at respective sides of the vehicle), which captures images exterior of the vehicle, with the camera having a lens for focusing images at or onto an imaging array or imaging plane or imager of the camera (FIG. 1). Optionally, a forward viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like). The vision system 12 includes a control or electronic control unit (ECU) 18 having electronic circuitry and associated software, with the electronic circuitry including a data processor or image processor that is operable to process image data captured by the camera or cameras, whereby the ECU may detect or determine presence of objects or the like and/or the system provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

Many Advanced Driver Assistance Systems (ADAS) obtain information about the surrounding environment through different sensors such as cameras, radar, ultrasonic sensors, and lidar. This information is used by various features (e.g., adaptive cruise control, lane centering systems, blind spot monitoring systems, etc.) to assist the driver while driving or operating a vehicle and/or for autonomous control of the vehicle. These ADAS features can use this information obtained from sensors to detect and warn the driver about potential threats around the vehicle and/or automatically maneuver the vehicle to avoid the potential threats.

Implementations herein include techniques that detect and alert occupants of the equipped vehicle about fast-approaching objects from behind the vehicle when the occupant begins or attempts to open any door of the vehicle (or may be contemplating opening a door after the vehicle is parked). This ensures the safety of the occupant inside the equipped vehicle as well as other road users who may collide with the opened or partially opened door. The system detects an object (e.g., a fast-moving object) from behind the equipped vehicle which may potentially collide with the equipped vehicle when, for example, an occupant attempts to open a door of the vehicle after the vehicle comes to a stop. That is, the system may detect when opening a door of the vehicle may cause a collision with another object (e.g., another vehicle, a bicycle, a pedestrian, etc.). The system may issue an alert alerting the occupants of such objects, restrain or prohibit the occupant from opening the door, and/or alert the oncoming object in order to prevent a collision or other mishap. The system accurately detects objects approaching the vehicle while minimizing or reducing false alerts (e.g., when the equipped vehicle is parked in an angled parking space).

To detect fast approaching objects from behind the equipped vehicle, the system may use information captured by rear corner radar sensors (disposed at the left rear corner region and the right rear corner region of the vehicle, such as at or near the taillights of the vehicle or at or near the rear bumper of the vehicle). Additionally or alternatively, the system may use data captured by a rear facing camera or other sensors (and optionally image data captured by the cameras and radar data captured by the radar sensors may be fused for processing at the ECU to detect presence of and motion of another object, such as another vehicle or bicyclist or pedestrian). Radar or other non-imaging sensors or image sensors (e.g., cameras) may provide object information such as longitudinal distance, lateral distance, and relative velocity of the object with respect to the equipped vehicle. Based on the object information, the system predicts whether an approaching object may collide with the equipped vehicle and/or with an open door of the vehicle. For example, the system determines a likelihood that the object will collide with the vehicle and, when the likelihood is greater than a threshold amount, the system takes action (e.g., alerts an occupant of the vehicle prior to the occupant opening the door, restricts the door from opening, audibly/visually alerts the oncoming object, etc.).

The system may determine additional information from captured sensor data such as heading angle of the detected object, lateral velocity of the detected object, etc., in order to reduce and minimize false alerts in some (e.g., angled) parking cases. The system may provide occupants and/or other persons outside the vehicle with a number of different alerts. The system may issue a visual alert such as a warning light at an A-pillar of the vehicle, in the side-mirrors, and/or lights disposed at the rear of the vehicle (e.g., brake lights, turn lights, etc.). Additionally or alternatively, the system may provide an audible alert (e.g., via a horn or a speaker of the vehicle). The system may provide the audible/visual alert when any fast-approaching object is detected inside a door opening warning zone and a time-to-collision (TTC) between the detected object and the vehicle is below a threshold value (e.g., 3 seconds, 3.5 seconds, 5 seconds, etc.).

Additionally or alternatively, the system may provide an audible alert to the occupant(s) of the vehicle. For example, when an occupant attempts to open a door of the vehicle that is on the same side of the vehicle that the system predicts the detected object will travel, the system may provide an audible alert (e.g., via speakers disposed within the vehicle). The system may provide a visual alert when the object is detected and escalate to an audible alert when the occupant attempts to open the door. The system may additionally or alternatively provide a haptic alert when an occupant attempts to open the door of the vehicle when a detected object is approaching the vehicle on that side. For example, the system could provide haptic feedback at the door handle or seat of the occupant. Optionally, the system may preclude opening of the vehicle door or limit an amount the door can be opened if the threat of impact is imminent.

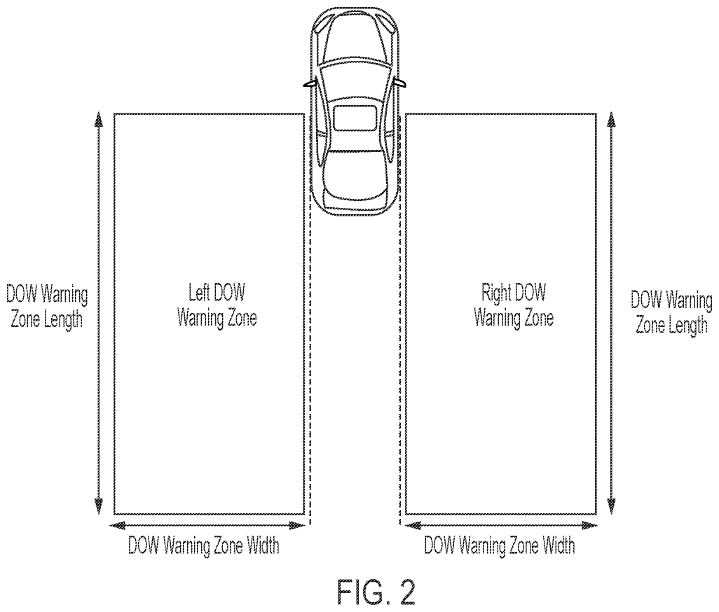

Referring now to FIG. 2, the system may include two or more door opening warning (DOW) zones. Optionally, each DOW zone starts longitudinally from around the B-pillar of the equipped vehicle (e.g., at or just behind the driver door) and extends along a length of the vehicle and parallel to a longitudinal axis of the vehicle and extends for a distance (e.g., at least 10 m, or at least 25 m, or at least 50 m, or at least 75 m, etc.) behind the host vehicle (i.e., the DOW Zone Length). Laterally, each DOW zone may start from a side most edge of the vehicle and extends laterally outboard from the side of the vehicle for a distance (e.g., at least 1.5 m, or at least 2 m, or at least 3 m, etc.) away from the vehicle (i.e., the DOW Zone Width). The system may alert an occupant when the detected object is inside this warning zone and a time-to-collision (TTC) of that object goes below a threshold (e.g., less than 3 seconds, or less than 3.5 seconds, or less than 5 seconds, etc.). That is, the system may alert the occupant and/or oncoming object when the system determines that there is a sufficient probability that the detected object will collide with the vehicle (e.g., the open door if the door were to be opened) in less than a threshold amount of time. The sizes of the DOW Zone Length, the DOW Zone Width, and/or the TTC threshold may be configurable (e.g., via one or more user inputs disposed within the vehicle). For example, a user of the vehicle may adjust the TTC threshold from 2 seconds to 3 seconds to cause the system to warn of additional objects (e.g., slower objects and/or objects further from the vehicle).

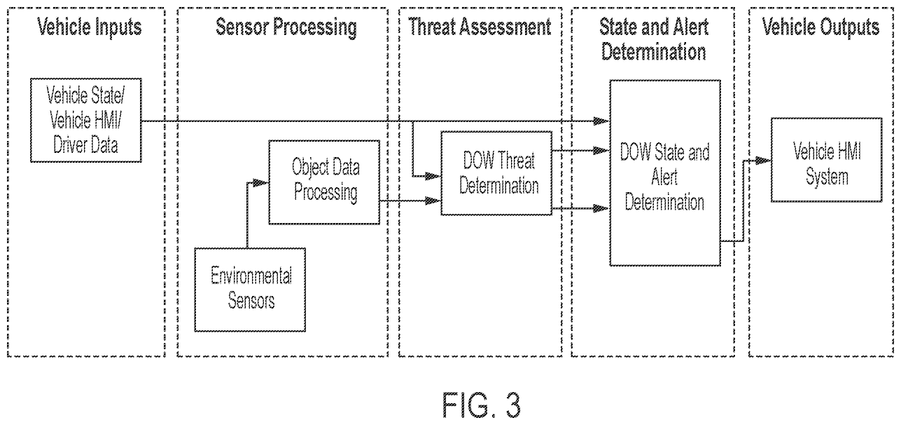

Referring now to FIG. 3, the system may include a number of modules or features. These modules may receive or obtain a number of vehicle inputs. These inputs may include signals related to the equipped vehicle's current state and driver interventions with the system such as vehicle gear information (drive, reverse, etc.), vehicle longitudinal speed (i.e., the vehicle speed relative to the road in a forward or reverse direction), door latch status (i.e., latched, unlatched), etc. The system may include a sensor processing module that receives the vehicle inputs and information from environmental sensors (e.g., cameras, radar, lidar, ultrasonic sensors, etc.) and processes the data to perform object detection. For example, the sensor processing module performs object detection to detect objects within the DOW zone(s) (FIG. 2). A threat assessment module may analyze sensor data and determine whether any objects detected by the sensor processing module are a threat. The system may perform object detection in response to determining a likelihood that an occupant of the vehicle may open a door of the vehicle in the near future. For example, the system may determine that the vehicle was recently placed in park (e.g., via the vehicle gear information and/or vehicle velocity information), and/or that an occupant's seatbelt has been removed, and/or that an occupant's hand has been placed on a door handle, and/or that a door handle has been actuated (releasing a latch of the door) to determine a likelihood that an occupant is going to open the door to leave the vehicle. When the likelihood exceeds a threshold value, the system may perform object detection. Alternatively, the system may wait for a predetermined trigger (e.g., the vehicle being placed in park, the door latch being disengaged, etc.) to begin object detection. Optionally, the system continuously detects objects, but only determines threats and/or generates alerts to occupants of the vehicle when the system determines that the likelihood that an occupant is leaving the vehicle exceeds a threshold value. That is, the system may suppress alerts/warnings whenever the system is disabled (e.g., the vehicle is moving or has been disabled by an occupant) or when the system determines the likelihood that an occupant is leaving the vehicle is below the threshold value.

The system may include a state and alert determination module. This block may determine different states of the system based on vehicle and environmental conditions and generate appropriate alerts (e.g., visual, audible, and/or haptic alerts). A vehicle outputs module may, for example, display visual alerts on a display or other human-machine interface (HMI) and/or play audible alerts based on input from the other modules. The system may utilize aspects of the communication system described in U.S. Pat. No. 9,688,199, which is hereby incorporated herein by reference in its entirety.

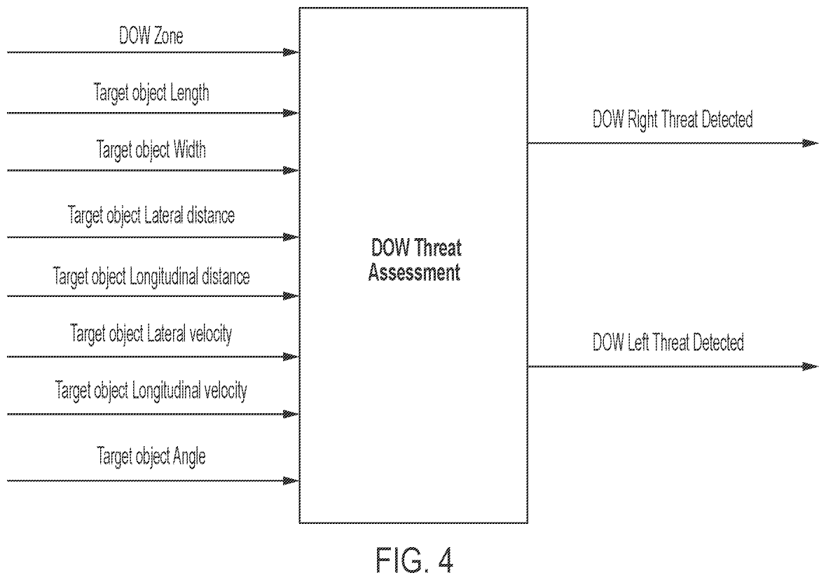

Referring now to FIG. 4, optionally, the system may include a DOW threat assessment module that determines whether a detected object (e.g., detected by the sensor processing module) located to the rear of the equipped vehicle is a threat or not (i.e., whether the object is of a sufficient threat to trigger action). The DOW threat assessment module may include a number of inputs such as (i) DOW Zone information, (ii) target object length, (iii) target object width, (iv) target object lateral distance, (v) target object longitudinal distance, (vi) target object lateral velocity, (vii) target object longitudinal velocity, and/or (viii) target object angle (i.e., relative to the vehicle). Outputs of the DOW threat assessment module may include a status output for each DOW Zone (e.g., a DOW right threat detected status when a threat is detected in a DOW zone located to the right of the vehicle and a DOW left threat detected status when a threat is detected in a DOW zone located to the left of the vehicle).

The DOW threat assessment module may receive the longitudinal and lateral distances between the target object and the equipped vehicle (i.e., how far behind and to the side of the vehicle the detected object currently is) and determines whether the detected object is within one of the DOW zones. For example, the system determines whether the longitudinal distance between the detected object and the equipped vehicle is less than a first threshold value (e.g., less than a first threshold distance from the rear of the vehicle) and whether the lateral distance between the detected object and the equipped vehicle is less than a second threshold value (e.g., less than a second threshold distance laterally from a centerline or side portion of the equipped vehicle).

The longitudinal distance may represent the distance in a longitudinal direction (i.e., parallel to a longitudinal centerline axis along a centerline of the vehicle) between the detected object and a transverse axis of the vehicle (i.e., an axis generally perpendicular to the longitudinal centerline axis of the vehicle and perpendicular to the side of the vehicle/the door of the vehicle). That is, the longitudinal distance represents how far the detected object is ahead or behind the vehicle or the door region of the vehicle. The lateral distance may represent the distance between the moving object and the side of the vehicle or a side longitudinal axis along the side of the vehicle (i.e., an axis parallel to the longitudinal centerline axis of the vehicle). That is, the lateral distance represents how far “outboard” the detected object is from the side of the vehicle. The longitudinal distance may be relative to any part of the vehicle (e.g., the center of the vehicle, a door of the vehicle, etc.), and the lateral distance may be relative to any point along the side of the vehicle or along the longitudinal side axis forward or rearward of the vehicle.

When the detected object is within one of the DOW zones, the DOW threat assessment module may determine whether the TTC of the detected object is below a threshold value (e.g., 3.5 seconds). That is, the system estimates or determines an amount of time until the detected object will collide with the equipped vehicle or pass within a threshold distance of the equipped vehicle (e.g., four feet). When the detected object has a TTC that is less than or below the threshold value, the system may identify the detected object as a threat. Thus, the system may classify an object as a threat only when the object is detected within a DOW zone, only when the object has a TTC below the threshold level, or only when the object is both within a DOW zone and has a TTC below the threshold level.

The system may perform additional checks (e.g., at the threat assessment module) to minimize the false alerts which are useful in case of angled parking. A false alert is defined as an alert generated by the system in response to determining a detected object is a threat when the detected object is not actually a threat (e.g., because the detected object is not going to collide with the vehicle door or pass near the vehicle). For example, when the equipped vehicle is parked in an angled parking space (i.e., the parking space is at a 30 to 90 degree angle relative to the road or lane used to access the parking space), a heading angle may be used to predict whether the detected object (e.g., another vehicle, a motorcycle, a bicycle, a pedestrian, etc.) is coming towards the equipped vehicle or going away from the equipped vehicle. Specifically, detected objects with heading angle greater than a threshold angle may be determined to be a false positive (e.g., because it is unlikely that the object will pass near close enough to a door of the vehicle to be a threat). In this case, the system may refrain from generating an alert for that particular detected object. For example, when a vehicle is parked in an angled parking space, an object may approach the vehicle from the rear, but due to the angle, will not pass by the doors of the vehicle, and thus pose no risk to colliding with an open door. In this scenario, the system may determine that the detected object is not a threat when the detected object has a heading angle relative to the vehicle that is greater than or lesser than a threshold value.

Similarly, the system may use lateral velocity to predict whether the detected object is coming toward the equipped vehicle or going away from the equipped vehicle. The lateral velocity may represent the speed of the detected object relative to (i.e., toward or away from) the longitudinal axis of the vehicle. The system may ignore detected objects with a lateral velocity greater than a threshold value or otherwise suppress any alert for such objects. By suppressing such alerts, the system helps reduce or prevent false alerts (i.e., false positives). For example, when a detected object has significant lateral velocity, the detected object will likely pass too far to the side of the vehicle to pose a risk of collision with a door. Longitudinal velocity of the detected object (i.e., velocity of the detected object relative to a transverse axis of the vehicle) may also be used to decide whether the detected object is a legitimate threat or not. This helps avoid false alerts due to opposite driving traffic. The system may incorporate any combination of heading, lateral velocity, and longitudinal velocity to help discern actual threats from false alarms.

Thresholds for heading (i.e., angle), lateral velocity, and/or longitudinal velocity may not be constant and instead may vary or be configured according to a longitudinal and/or lateral distances between the detected object and the equipped vehicle. Optionally, thresholds may be relatively high when the detected object is far away from the equipped vehicle, and the threshold(s) may be reduced or get smaller as the detected object approaches the equipped vehicle. For example, a detected object that is 30 meters away from the equipped vehicle may have higher thresholds associated with it than a detected object that is 10 meters away from the equipped vehicle.

The system may implement such a variable threshold technique to ensure that the system does not miss an actual alert because of stringent checks on lateral/longitudinal velocity and/or angle/heading. That is, the variable threshold ensures that an alert for an actual threat is not inadvertently suppressed. This is helpful, for example, in issuing a timely warning to an occupant of the vehicle in cases where the lateral velocity or angle of the detected object (relative to the equipped vehicle) is large when the detected object is a large distance from the equipped vehicle but the quantities (i.e., of the velocity and/or angle) reduce as the target object comes closer to the host vehicle. Optionally, to reduce unwanted alert interruptions and instead output a continuous alert, hysteresis may be added to the distances, velocities, and/or headings of the detected object. The hysteresis helps allow the system to obtain a continuous alert in cases where the detected object's quantities (i.e., distances, velocities, and/or angles) are fluctuating at boundary values (i.e., at threshold values). The system may include enable and disable delays (hysteresis) to prevent false alerts due to sudden jumps in the detected object's quantities (e.g., due to signal noise).

Thus, implementations herein include a door opening warning system for detecting objects approaching the vehicle and providing warnings or alerts of the detected objects to occupants of the equipped vehicle. The system may use one or more rear sensors (e.g., cameras, radar, lidar, ultrasonic sensors, etc.) to detect potential threats (i.e., approaching objects). The sensors may include corner radar sensors (i.e., radar sensors disposed at the rear corners of the vehicle) and/or one or more cameras disposed at the rear of the vehicle and/or at the side mirrors of the vehicle. The system may provide visual alerts (e.g., lights or displays located at side mirrors, pillars, or interior the vehicle), audible alerts, and/or haptic alerts (e.g., vibrations in the seat, steering wheel, door handle, etc.).

The system may determine a lateral and/or longitudinal distance between each detected object and the equipped vehicle) based on processing of sensor data captured by the sensors. The system may determine whether the detected object within zones established to the side and behind the equipped vehicle and whether lateral and/or longitudinal velocities and/or headings (i.e., angles) of the detected object quality the detected object as a threat. The system may include a left zone and a right zone to detect objects passing to the left of the equipped vehicle and to the right of the equipped vehicle, respectively. The system may compare the velocities and headings of the detected object against configurable or adaptive thresholds to determine whether detected objects within the zone(s) are a threat or a false positive. The lateral distance threshold may be a function of the longitudinal distance of the object. That is, the threshold values may adjust based on the distances between the detected object and the equipped vehicle.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor or camera may capture image data for image processing and may comprise any suitable camera or sensing device, such as, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or pixels arranged in rows and columns. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

The system may utilize sensors, such as radar sensors or imaging radar sensors or lidar sensors or the like, to detect presence of and/or range to other vehicles and objects at the intersection. The sensing system may utilize aspects of the systems described in U.S. Pat. Nos. 10,866,306; 9,954,955; 9,869,762; 9,753,121; 9,689,967; 9,599,702; 9,575,160; 9,146,898; 9,036,026; 8,027,029; 8,013,780; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 7,053,357; 6,919,549; 6,906,793; 6,876,775; 6,710,770; 6,690,354; 6,678,039; 6,674,895 and/or 6,587,186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

The radar sensors of the sensing system each comprise a plurality of transmitters that transmit radio signals via a plurality of antennas, a plurality of receivers that receive radio signals via the plurality of antennas, with the received radio signals being transmitted radio signals that are reflected from an object present in the field of sensing of the respective radar sensor. The system includes an ECU or control that includes a data processor for processing sensor data captured by the radar sensors. The ECU or sensing system may be part of a driving assist system of the vehicle, with the driving assist system controls at least one function or feature of the vehicle (such as to provide autonomous driving control of the vehicle) responsive to processing of the data captured by the radar sensors.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular alert system, the vehicular alert system comprising:
a sensor disposed at a vehicle equipped with the vehicular alert system, the sensor sensing exterior of the vehicle and capturing sensor data;
an electronic control unit (ECU) comprising electronic circuitry and associated software;
wherein the electronic circuitry of the ECU comprises a processor for processing sensor data captured by the sensor;
wherein the vehicular alert system determines a likelihood that an occupant of the vehicle is going to exit the vehicle via a door of the vehicle;
wherein the processor processes sensor data captured by the sensor to detect a moving object present exterior of the vehicle;
wherein, responsive to detecting the moving object, the vehicular alert system determines that the moving object is moving toward the door of the vehicle;
wherein, responsive to determining the likelihood the occupant of the vehicle is going to exit the vehicle via the door of the vehicle, and responsive to determining that the detected moving object is moving toward the door of the vehicle, the vehicular alert system (i) determines distance between the detected moving object and the door of the vehicle, and (ii) determines a heading angle of the detected moving object relative to the vehicle;
wherein the vehicular alert system determines whether the detected moving object is a threat based at least in part on (i) the determined distance and (ii) the determined heading angle; and
wherein the vehicular alert system, responsive to determining that the detected moving object is a threat, alerts the occupant of the vehicle.

2. The vehicular alert system of claim 1, wherein the vehicular alert system determines whether the detected moving object is present within a door opening warning zone.

3. The vehicular alert system of claim 2, wherein the door opening warning zone comprises a left door opening warning zone and a right door opening warning zone.

4. The vehicular alert system of claim 1, wherein the vehicular alert system determines the detected moving object is a threat at least in part by determining a time to collision between the detected moving object and the vehicle.

5. The vehicular alert system of claim 4, wherein the vehicular alert system determines the detected moving object is a threat when the time to collision (TTC) is below a TTC threshold value.

6. The vehicular alert system of claim 1, wherein the vehicular alert system at least in part determines the detected moving object is a threat when the heading angle is less than a heading threshold value.

7. The vehicular alert system of claim 6, wherein the heading threshold value is dependent upon a distance between the detected moving object and the vehicle.

8. The vehicular alert system of claim 1, wherein the vehicular alert system determines the distance between the detected moving object and the door of the vehicle by (i) determining a longitudinal distance representing a distance between the moving object and a transverse axis of the vehicle that extends through the door of the vehicle and (ii) a lateral distance representing a distance between the moving object and a longitudinal axis of the vehicle that extends along a side of the vehicle at which the door is located.

9. The vehicular alert system of claim 1, wherein the vehicular alert system determines the detected moving object is a threat based in part on a lateral velocity of the detected moving object relative to the vehicle, wherein the lateral velocity represents a velocity of the detected moving object parallel to a longitudinal axis of the vehicle.

10. The vehicular alert system of claim 9, wherein the vehicular alert system determines that the moving object is moving toward the door of the vehicle at least in part responsive to determination that the lateral velocity of the detected moving object relative to the vehicle is less than a threshold value, and wherein the threshold value is dependent upon a distance between the detected moving object and the vehicle.

11. The vehicular alert system of claim 1, wherein the vehicular alert system determines that the moving object is moving toward the door of the vehicle based at least in part on a longitudinal velocity of the detected moving object relative to the vehicle, wherein the longitudinal velocity represents a velocity of the detected moving object parallel to a longitudinal axis of the vehicle.

12. The vehicular alert system of claim 1, wherein the alert comprises at least one selected from the group consisting of (i) a visual alert, (ii) an audible alert and (iii) a haptic alert.

13. The vehicular alert system of claim 1, wherein the alert alerts the detected moving object.

14. The vehicular alert system of claim 1, wherein the detected moving object is another vehicle.

15. The vehicular alert system of claim 1, wherein the detected moving object is a bicyclist.

16. The vehicular alert system of claim 1, wherein the detected moving object is a pedestrian.

17. The vehicular alert system of claim 1, wherein the sensor comprises at least one radar sensor disposed at a side region of the vehicle.

18. A vehicular alert system, the vehicular alert system comprising:
a sensor disposed at a vehicle equipped with the vehicular alert system, the sensor sensing exterior of the vehicle and capturing sensor data;
an electronic control unit (ECU) comprising electronic circuitry and associated software;
wherein the electronic circuitry of the ECU comprises a processor for processing sensor data captured by the sensor;
wherein the vehicular alert system determines a likelihood that an occupant of the vehicle is going to exit the vehicle via a door of the vehicle;
wherein the processor processes sensor data captured by the sensor to detect a moving object present exterior of the vehicle;
wherein, responsive to detecting the moving object, the vehicular alert system determines that the moving object is moving toward the door of the vehicle;
wherein the vehicular alert system determines whether the detected moving object is present within a door opening warning zone of the vehicle;
wherein, responsive to determining the likelihood the occupant of the vehicle is going to exit the vehicle via the door of the vehicle, and responsive to determining that the detected moving object is moving toward the door of the vehicle, and responsive to determining that the detected moving object is present within the door opening warning zone of the vehicle, the vehicular alert system (i) determines distance between the detected moving object and the door of the vehicle, and (ii) determines a heading angle of the detected moving object relative to the vehicle;
wherein the vehicular alert system determines a time to collision (TTC) based on (i) the determined distance and (ii) the determined heading angle;
wherein the vehicular alert system determines whether the detected moving object is a threat when the TTC is below a TTC threshold value; and
wherein the vehicular alert system, responsive to determining that the detected moving object is a threat, alerts the occupant of the vehicle.

19. The vehicular alert system of claim 18, wherein the door opening warning zone comprises a left door opening warning zone and a right door opening warning zone.

20. The vehicular alert system of claim 18, wherein the vehicular alert system at least in part determines the detected moving object is a threat when the heading angle is less than a heading threshold value.

21. The vehicular alert system of claim 20, wherein the heading threshold value is dependent upon a distance between the detected moving object and the vehicle.

22. A vehicular alert system, the vehicular alert system comprising:
a sensor disposed at a vehicle equipped with the vehicular alert system, the sensor sensing exterior of the vehicle and capturing sensor data;
an electronic control unit (ECU) comprising electronic circuitry and associated software;
wherein the electronic circuitry of the ECU comprises a processor for processing sensor data captured by the sensor;
wherein the processor processes sensor data captured by the sensor to detect a moving object present exterior of the vehicle;
wherein, responsive to detecting the moving object, the vehicular alert system determines that the moving object is moving toward a door of the vehicle;
wherein, responsive to determining that the detected moving object is moving toward the door of the vehicle, the vehicular alert system (i) determines distance between the detected moving object and the door of the vehicle, and (ii) determines a heading angle of the detected moving object relative to the vehicle;
wherein the vehicular alert system determines whether the detected moving object is a threat based at least in part on (i) determining that the determined distance is less than a distance threshold value and (ii) determining that the determined heading angle is less than a heading threshold value; and
wherein the vehicular alert system, responsive to determining that the detected moving object is a threat, alerts an occupant of the vehicle.

23. The vehicular alert system of claim 22, wherein the vehicular alert system determines the detected moving object is a threat at least in part by determining a time to collision between the detected moving object and the vehicle.

24. The vehicular alert system of claim 23, wherein the vehicular alert system determines the detected moving object is a threat when the time to collision (TTC) is below a TTC threshold value.
